(19) United States
(12) Patent Application Publication
(10) Pub. No.: US 2016/0112874 A1
(43) Pub. Date: Apr. 21, 2016

(54) SECURE ELEMENT OPERATING SYSTEM AND METHOD

(71) Applicant: CHINA UNIONPAY CO., LTD., Shanghai (CN)

(72) Inventors: Hongfeng CHAI, Shanghai (CN); Zhijun Lu, Shanghai (CN); Shuo He, Shanghai (CN); Wei Guo, Shanghai (CN); Yu Zhou, Shanghai (CN); Bin Yu, Shanghai (CN)

(73) Assignee: CHINA UNIONPAY CO., LTD., Shanghai (CN)

(21) Appl. No.: 14/891,382

(22) PCT Filed: May 14, 2014
(86) PCT No.: PCT/CN2014/077461

§ 371 Date: Nov. 16, 2015

(30) Foreign Application Priority Data
May 22, 2013 (CN) 201310191130.3

(51) Int. Cl. H04W 12/06; H04B 1/3816

(52) U.S. Cl. CPC H04W 12/06; H04B 1/3816

(57) ABSTRACT

The invention discloses a secure element (SE) operating system and method. The system comprises a SE configurator and a protocol converter disposed inside a mobile communication device, wherein the SE configurator communicates with one or more SEs on the mobile communication device via the protocol converter, and the SE configurator comprises a SE list for storing information on said one or more SEs.

### FIELD OF THE INVENTION

The invention relates to a secure element on a mobile communication device, and in particular to a secure element operating system and method.

### BACKGROUND

An operating system of a conventional mobile communication system can not perform a uniform configuration and resource distribution on secure elements (SE) such as SIM card, smart SD card or the like, which would increase resource consumption of a processor of the device. Second, the SEs interacts with the device independently, which presents a safety hazard. On the other hand, the operations on each SE (e.g., addition or deletion on a mobile communication device) would decrease the convenience in operation.

### SUMMARY OF THE INVENTION

According to an object of the invention, a secure element (SE) operating system is disclosed, which comprises a SE configurator and a protocol converter disposed inside a mobile communication device, wherein the SE configurator communicates with one or more SEs on the mobile communication device via the protocol converter, and the SE configurator comprises a SE list for storing information on said one or more SEs.

Optionally, the SE configurator is used to acquire the information on said one or more SEs on the mobile communication device via the protocol converter, and to add the information to the SE list.

Optionally, the SE configurator verifies said one or more SEs before acquiring the information on said one or more SEs.

Optionally, the SE configurator is further configured to present the information on said one or more SEs via the mobile communication device based on the SE list.

Optionally, the SE configurator is further configured to delete the information on said one or more SEs based on the SE list.

Optionally, said one or more SEs is a physical SE or a virtual SE.

Optionally, the secure element operating system further comprises a SE management backstage for forwarding information between the SE configurator and a trusted service management (TSM) platform.

Optionally, the SE management backstage is used for acquiring the information on a designated SE from the SE configurator and sending the information on the designated SE to the TSM platform, the SE management backstage is further configured to receive download information on the designated SE from the TSM platform, and to forward the download information to the SE configurator, wherein the SE configurator is used for forwarding the download information to the corresponding designated SE via the protocol converter so that the designated SE can generate an application according to the download information.

Optionally, the SE management backstage is further configured to communicate with the SE configurator, and to control the SE configurator to perform addition, verification, inquiry and deletion operations on the SE.

Optionally, the designated SE is designated by selecting SE in the SE list of the SE configurator.

According to another object of the invention, a secure element (SE) operating method is disclosed, which comprises the following steps: disposing a SE configurator and a protocol converter inside a mobile communication device; the SE configurator communicating with one or more SEs on the mobile communication device via the protocol converter, wherein the SE configurator comprises a SE list for storing information on said one or more SEs.

Optionally, the method further comprises the step of: the SE configurator acquiring the information on said one or more SEs on the mobile communication device via the protocol converter, and adding the information to the SE list.

Optionally, the method further comprises the step of: the SE configurator verifying said one or more SEs before acquiring the information on said one or more SEs.

Optionally, the method further comprises the step of: the SE configurator presenting the information on said one or more SEs via the mobile communication device based on the SE list.

Optionally, the method further comprises the step of: the SE configurator deleting the information on said one or more SEs based on the SE list.

Optionally, said one or more SEs is a physical SE or a virtual SE.

Optionally, the method further comprises the step of: providing a SE management backstage for forwarding information between the SE configurator and a trusted service management (TSM) platform.

Optionally, the method further comprises the step of: the SE management backstage acquiring the information on a designated SE from the SE configurator and sending the information on the designated SE to the TSM platform, the SE management backstage receiving download information on the designated SE from the TSM platform, and forwarding the download information to the SE configurator, and the SE configurator forwarding the download information to the corresponding designated SE via the protocol converter so that the designated SE can generate an application according to the download information.

Optionally, the SE management backstage further communicates with the SE configurator, and controls the SE configurator to perform addition, verification, inquiry and deletion operations on the SE.

Optionally, the designated SE is designated by selecting SE in the SE list of the SE configurator.

### BRIEF DESCRIPTION OF THE DRAWINGS

Those skilled in the art will comprehend various aspects of the invention more clearly after reading the specific embodiments of the invention with reference to the accompanying drawings. It will be appreciated by those skilled in the art that the drawings are merely used for explaining the technical solutions of the invention in connection with the specific embodiments, and are not intended to limit the scope of protection of the invention.

FIG. 1 is a schematic view of the secure element operating system according to an embodiment of the invention.

FIG. 2 is a schematic view of the secure element operating system according to another embodiment of the invention.

### DETAILED DESCRIPTION OF THE UTILITY MODEL

Herein, the secure element (SE) refers to an independent module having computing and storing functions, in which respective functions are designed so as to protect the safety of the stored data and provide corresponding secure mechanism service for use by external devices. The SE can for example comprise real physical hardware elements such as SIM card, smart SD card or the like, or virtual elements.

The specific embodiments of the invention will be further described in detail hereinafter with reference to the accompanying drawings. In the following description, for an illustrative purpose, many specific details are described so as to provide a thorough understanding of one or more aspects of the embodiments. However, it is obvious to those skilled in the art that one or more aspects of various embodiments can be implemented with these specific details provided to a less degree. Therefore, the following description should not be considered as limiting; rather, the scope of protection is defined by the appended claims.

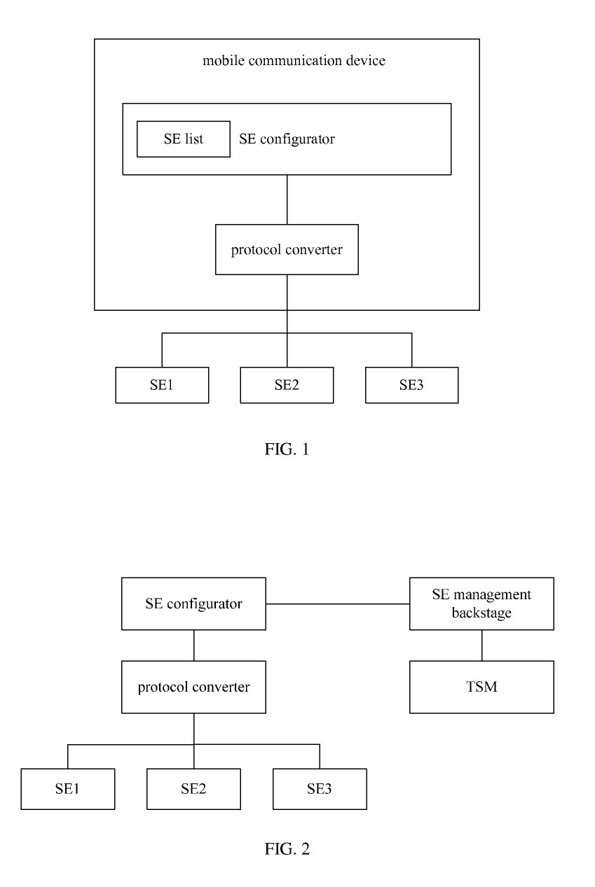

FIG. 1 is a schematic view of the secure element operating system according to an embodiment of the invention. As shown in FIG. 1, the secure element operating system according to the invention comprises a SE configurator and a protocol converter. The SE configurator and the protocol converter can be disposed inside a mobile communication device. The SE configurator communicates with one or more SEs on the mobile communication device via the protocol converter, and the SE configurator comprises a SE list for storing information on one or more SEs. While FIG. 1 shows three SEs, those skilled in the art will understand that the number of SEs can be more than three or less than three.

The SE configurator can be used to acquire the information on said one or more SEs on the mobile communication device via the protocol converter, and to store the information in the SE list (add SE). The one or more SEs can be a physical SE (e.g., SIM card, SD card) or a virtual SE established by the operating system of the device.

The SE configurator can verify the one or more SEs connected to the mobile communication device before acquiring the information on said one or more SEs. The SE that fails the verification cannot be added to the SE list.

The SE configurator can be also configured to present the information on the one or more SEs via the mobile communication device based on the SE list so as to facilitate the user in inquiring SE information.

The SE configurator can be also configured to delete the information on the one or more SEs based on the SE list so as to perform logout of SE in the mobile communication device.

Those skilled in the art may understand that the SE configurator can be implemented as a functional module added into the mobile communication device.

FIG. 2 is a schematic view of the secure element operating system according to another embodiment of the invention. As shown, the secure element operating system may further comprise a SE management backstage which can be used forwarding information between the SE configurator and a trusted service management (TSM) platform. For example, the SE management backstage can be used for acquiring the information on a designated SE from the SE configurator and send the information on the designated SE to the TSM platform. The SE management backstage can be further configured to receive download information on the designated SE from the TSM platform, and to forward the download information to the SE configurator. At this time, the SE configurator is used for forwarding the download information to the corresponding designated SE via the protocol converter so that the designated SE can generate an application according to the download information.

The SE management backstage can be further configured to communicate with the SE configurator, and to control the SE configurator to perform addition, verification, inquiry and deletion operations on the SE.

Herein, the trusted service management (TSM) refers to a technology for realizing a plurality of applications on one SE. In the prior art, the TSM platform can issue various smart card applications or the like remotely for users. That is, users can download applications from a remote TSM platform.

In this embodiment, the designated SE can be designated by selecting SE in the SE list of the SE configurator.

According to the invention, the SE configurator and the protocol converter are disposed inside the mobile communication device, and the secure element management backstage is provided outside, whereby the configuration and resource distribution are realized for the secure element and a basic service is provided to the device. By doing so, resource consumption of the device can be reduced and safety is improved, and meanwhile, a uniform invoking service of the SE is provided for a higher level application of the device and the convenience of using SE is increased.

Through the description of the above embodiments, those skilled in the art will understand that various modifications and variations can be also made to the specific embodiments of the invention without departing from the spirit and scope of the invention. All these modifications and variations will fall within the scope defined by the appended claims of the invention.

1. A secure element (SE) operating system characterized by comprising a SE configurator and a protocol converter disposed inside a mobile communication device, wherein,
the SE configurator communicates with one or more SEs on the mobile communication device via the protocol converter, and
the SE configurator comprises a SE list for storing information on said one or more SEs.

2. The system according to claim 1, characterized in that the SE configurator is used to acquire the information on said one or more SEs on the mobile communication device via the protocol converter, and to add the information to the SE list,
the SE configurator is further configured to present the information on said one or more SEs via the mobile communication device based on the SE list, and
the SE configurator is further configured to delete the information on said one or more SEs based on the SE list.

3. The system according to claim 2, characterized in that the SE configurator verifies said one or more SEs before acquiring the information on said one or more SEs.

4. The system according to claim 1, characterized in that said one or more SEs is a physical SE or a virtual SE.

5. The system according to claim 1, characterized in that the system further comprises a SE management backstage for forwarding information between the SE configurator and a trusted service management (TSM) platform.

6. A system according to claim 7, characterized in that the SE management backstage is used for acquiring the information on a designated SE from the SE configurator and sending the information on the designated SE to the TSM platform,
the SE management backstage is further configured to receive download information on the designated SE from the TSM platform, and to forward the download information to the SE configurator, and
the SE configurator is used for forwarding the download information to the corresponding designated SE via the protocol converter so that the designated SE can generate an application according to the download information.

7. A system according to claim 6, characterized in that the SE management backstage is further configured to communicate with the SE configurator, and to control the SE configurator to perform addition, verification, inquiry and deletion operations on the SE.

8. A system according to claim 1, characterized in that the designated SE is designated by selecting SE in the SE list of the SE configurator.

9. A secure element (SE) operating method, characterized by comprising the following steps:
disposing a SE configurator and a protocol converter inside a mobile communication device,
the SE configurator communicating with one or more SEs on the mobile communication device via the protocol converter, wherein
the SE configurator comprises a SE list for storing information on said one or more SEs.

10. A method according to claim 9, characterized by further comprising the steps of:
the SE configurator acquiring the information on said one or more SEs on the mobile communication device via the protocol converter, and adding the information to the SE list;
the SE configurator presenting the information on said one or more SEs via the mobile communication device based on the SE list; and
the SE configurator deleting the information on said one or more SEs based on the SE list.

11. A method according to claim 10, characterized by further comprising the step of:
the SE configurator verifying said one or more SEs before acquiring the information on said one or more SEs.

12. A method according to claim 9, characterized in that said one or more SEs is a physical SE or a virtual SE.

13. A method according to claim 9, characterized by further comprising the step of:
providing a SE management backstage, and using the SE management backstage for forwarding information between the SE configurator and a trusted service management (TSM) platform.

14. A method according to claim 13, characterized by further comprising the step of:
the SE management backstage acquiring the information on a designated SE from the SE configurator and sending the information on the designated SE to the TSM platform,
the SE management backstage receiving download information on the designated SE from the TSM platform, and forwarding the download information to the SE configurator, and
the SE configurator forwarding the download information to the corresponding designated SE via the protocol converter so that the designated SE can generate an application according to the download information.

15. A method according to claim 14, characterized in that the SE management backstage further communicates with the SE configurator, and controls the SE configurator to perform addition, verification, inquiry and deletion operations on the SE.

16. A method according to claim 9, characterized in that the designated SE is designated by selecting SE in the SE list of the SE configurator.
